(19) United States
(12) Patent Application Publication
(10) Pub. No.: US 2026/0023417 A1
(43) Pub. Date: Jan. 22, 2026

(54) Two-Stage Thermal Throttling

(71) Applicant: Google LLC, Mountain View, CA (US)

(72) Inventors: Mohsen Heidarinejad, San Jose, CA (US); Arpit Mittal, San Jose, CA (US); Sayanna Chandula, San Jose, CA (US); Wei Wang, Palo Alto, CA (US)

(73) Assignee: Google LLC, Mountain View, CA (US)

(21) Appl. No.: 18/774,530

(22) Filed: Jul. 16, 2024

(51) Int. Cl. G06F 1/20

(52) U.S. Cl. CPC G06F 1/20

(57) ABSTRACT

Techniques and apparatuses are described that implement two-stage thermal throttling. In some examples, two-stage thermal throttling of a mobile device is achieved using a main controller and an auxiliary controller. The auxiliary controller can be a proportional controller that monitors a temperature and a rate of change of the temperature of the mobile device during operations. When a first temperature threshold and a threshold rate of increase of the temperature are exceeded by the mobile device, the auxiliary controller can throttle a metric of the device to slow down the rate of increase of the temperature. After the temperature has exceeded a second temperature threshold, the auxiliary controller can hand off control to the main controller, which can further throttle the metric of the device or one or more additional metrics of the device.

### BACKGROUND

Mobile devices such as cellular telephones, smart phones, and other handheld or portable electronic devices such as personal digital assistants (PDAs), headsets, MP3 players, etc. have become popular and ubiquitous. Such mobile devices are capable of performing different tasks including executing software. The components of the mobile devices and the executing of software can increase a temperature of the mobile devices. Temperature increases above a certain threshold can cause damage to components of the mobile device. To avoid such damage, the temperature has to be controlled efficiently.

### SUMMARY

Techniques and apparatuses are described that implement two-stage thermal throttling. In some examples, two-stage thermal throttling of a mobile device is achieved using a main controller and an auxiliary controller. The auxiliary controller can be a proportional controller that monitors a temperature and a rate of change of the temperature of the mobile device during operations. When a first temperature threshold and a threshold rate of increase of the temperature are exceeded by the mobile device, the auxiliary controller can throttle a metric of the device to slow down the rate of increase of the temperature. After the temperature has exceeded a second temperature threshold, the auxiliary controller can hand off control to a main controller that can further throttle the metric of the device or one or more additional metrics of the device.

The main controller can be a Proportional and Integral (PI) controller that can throttle the metric in a more aggressive manner than the auxiliary controller. The auxiliary controller can hand off thermal data and historical data to the main controller so the that main controller can thermally control the device without first accumulating historical device-temperature data from scratch. The second temperature threshold can be greater than the first temperature threshold and can be at a temperature where more drastic measures are needed to control the temperature of the mobile device to prevent damage to the mobile device. In this example, the auxiliary controller is used to slow down the rate of change or the increase in temperature before the temperature reaches the second temperature threshold. Reducing the rate of change of the temperature in this manner can ensure that the actions of the main controller are not purely reactionary and can balance a user experience of the mobile device with thermal throttling policies.

Aspects described below include a method performed by an auxiliary controller and a main controller for two-stage thermal throttling. The method includes obtaining, by an auxiliary controller of a device, thermal information regarding a temperature of the device and a first rate of increase of the temperature. The method also includes determining that the temperature has exceeded a first threshold at a first temperature and that the first rate of increase of the temperature has exceeded a threshold rate of change. The method also includes throttling, by the auxiliary controller, a metric of the device to a first level to adjust the first rate of increase of the temperature to a second rate of increase in response to the first threshold and the threshold rate of change being exceeded. The method also includes determining that the temperature of the device has exceeded a second threshold at a second temperature. The method also includes sending the thermal information and historical data regarding actions of the auxiliary controller to a main controller of the device in response to the temperature exceeding the second threshold. The method also includes handing off thermal control of the device to the main controller from the auxiliary controller in response to the temperature of the device exceeding the second threshold. The method also includes throttling, by the main controller, the metric of the device to a second level to adjust the temperature of the device.

Aspects described below also include an apparatus comprising a device or mobile device with an auxiliary controller and a main controller configured to perform any of the described methods.

Aspects described below include a computer-readable storage medium comprising computer-executable instructions that, responsive to execution by a processor, cause an auxiliary controller and a main controller of a device to perform any one of the described methods.

### BRIEF DESCRIPTION OF DRAWINGS

Apparatuses for and techniques for two-stage thermal throttling are described with reference to the following drawings. The same numbers are used throughout the drawings to reference like features and components:

FIG. 1 illustrates an example environment in which two-stage thermal throttling can be implemented;

FIG. 2 illustrates an example implementation of a computing device that can implement aspects of two-stage thermal throttling;

FIG. 3 illustrates a block diagram of an example flow for two-stage thermal throttling;

FIGS. 4A-D illustrates graphs of thermal data associated with two-stage thermal throttling;

FIG. 5 illustrates an example method for performing an aspect of two-stage thermal throttling; and

FIG. 6 illustrates an example computing system embodying, or in which techniques may be implemented that enable use of, two-stage thermal throttling.

### DETAILED DESCRIPTION

### Overview

Mobile devices, including cellular telephones, smart phones, personal digital assistants (PDAs), headsets, MP3 players, etc., generate heat during operations such as processing software, discharging a battery, running a display, etc. The heat can exceed a temperature threshold and damage the components of the mobile device. Due to space limitations in a small form factor, mobile devices, such as smart phones, typically do not have fans, cooling fins, or other hardware dedicated to cooling the device that may be found in larger electronic or computing devices. Therefore, hardware solutions for cooling down a mobile device can be difficult to implement. When the mobile device is operating and executing software, such as an app, techniques can be employed to reduce the temperature of the mobile device to ensure safety of the device and compliance with a policy set for the mobile device. Such techniques can be described as a software solution for cooling the mobile device. A policy can be set to monitor and control the temperature of the mobile device.

One technique for cooling a mobile device or controlling the temperature of the mobile device includes decreasing a processing speed of the mobile device. Decreasing a speed of processing or slowing a different metric associated with the mobile device can result in less heat generated by the mobile device and enable existing heat to be dissipated, but this technique can also negatively impact a user experience associated with the mobile device. For example, if the mobile device is executing a game, slowing the processing speed of the mobile device can impact the performance of the game executing on the mobile device. Another technique to control the temperature of the mobile device includes shutting down the mobile device once the temperature of the mobile device reaches a certain temperature threshold, which can also negatively impact the user experience. Software control mechanisms can be used to reactively control the temperature of the mobile device. In other words, a reactive technique may not control a temperature of the mobile device until the mobile device has exceeded a temperature threshold and has become too hot. Voluntarily restricting the operation of the mobile device can negatively impact the user experience associated with the mobile device and may or may not be necessary to prevent damage caused by excessive heat to the mobile device. A solution or technique is needed that can balance controlling or throttling the performance of the mobile device with limiting a negative impact on the user experience of the mobile device.

A software solution may not have a reaction time that is as fast as a hardware solution and can create a bottleneck in responding to increased temperatures. A software solution itself can also cause additional heat to be generated by executing and monitoring a temperature of the mobile device. Therefore, using software to control a thermal temperature of a device has a tradeoff. A software solution can read sensor data from sensors associated with the mobile device to determine a temperature of the mobile device.

In one solution, an aggressive controller can use gain tunings, but the gain tuning affects closed-loop system transient behavior and general system robustness and may lead to an unstable thermal system with severe thermal implications. Another solution is to control the temperature at a lower temperature target, which can help but can severely degrade overall performance. This performance regression can significantly impact the consumer electronics user experience.

Another solution can employ a PI controller that is widely used in the industry to address thermal control problems due to the simplicity and robustness of the PI controller. One of the shortcomings of the PI controller is that, at a launch period, the PI controller needs to accumulate a history of the tracked temperature to address temperature control. Such history accumulation causes a delay in thermal throttling enforcement. This delay may lead to high temperature overshoot, which is an undesirable thermal phenomenon. Temperature overshoot is more likely to occur when the controlled temperature evolves on a rapid dynamic scale. An example of this dynamic scale can be a smart phone silicon/die temperature.

To address the above-described challenges, techniques are described that implement two-stage thermal throttling. An auxiliary controller for thermal throttling can be included and employed before a main controller is employed by a mobile device. The auxiliary controller can perform a lighter throttling process, as compared to the main controller, to damp a high initial temperature ramp rate that a mobile device may experience.

In an example, two-stage thermal throttling of a mobile device is achieved using a main controller and an auxiliary controller. The auxiliary controller can be a proportional controller that monitors a temperature of the mobile device and a rate of change of the temperature of the mobile device during operations. When a first temperature threshold and a threshold rate of change of the temperature are exceeded by a rising temperature of the mobile device, then the auxiliary controller can throttle a metric of the device to decrease the rate of change of the temperature. After the rising temperature has exceeded a second temperature threshold, then the auxiliary controller can hand off control to a main controller that can further throttle the metric of the device. The main controller can be a Proportional Integral (PI) controller configured to throttle the metric in a more aggressive manner than the auxiliary controller. The auxiliary controller can hand off thermal data and historical data to the main controller so that the main controller can thermally control the device without first accumulating historical device-temperature data about the device from scratch. The second temperature threshold can be greater than the first temperature threshold and can be at a temperature where more drastic measures are needed to control the temperature of the mobile device to prevent damage to the mobile device. In this example, the auxiliary controller can be used to reduce the rate of change or the rate of increase in temperature before the rising temperature reaches the second temperature threshold. Implementing the auxiliary controller in this manner can ensure that the actions of the main controller are not purely reactionary and can balance the user experience of the mobile device with thermal throttling policies.

### Operating Environment

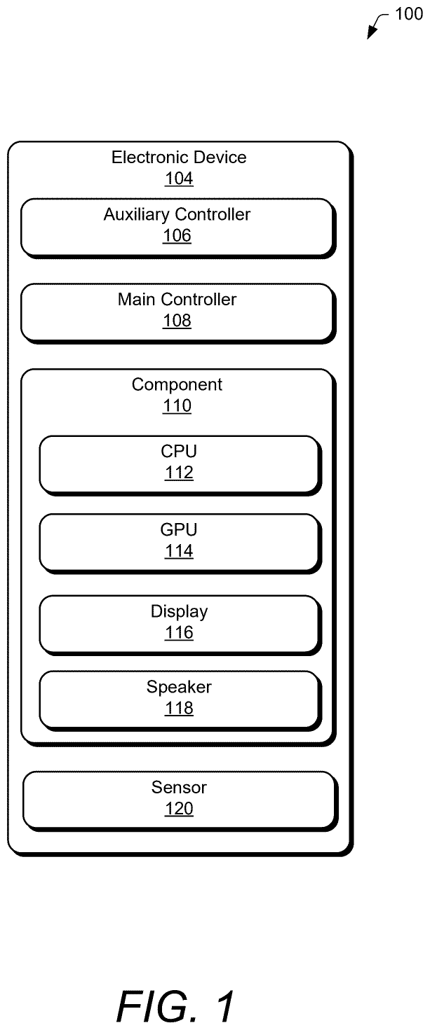

FIG. 1 is an illustration of an example environment 100 in which two-stage thermal throttling can be implemented. The example environment 100 can include an electronic device 104 that includes an auxiliary controller 106 and a main controller 108. The electronic device 104 can include various components such as a component 110, which can include a central processing unit (CPU) 112, a graphical processing unit (GPU) 114, a display 116, and/or a speaker 118. The component 110 can generate heat during normal operations of the electronic device 104. The electronic device 104 can include two or more components that can each generate heat during operation of the electronic device 104. The electronic device 104 can be any type of device. In one example, the electronic device 104 is a small form factor electronic device, such as a mobile device or a wearable device. The mobile device can be, but is not limited, to a smart phone. One example of the wearable device is a smartwatch.

The auxiliary controller 106 and the main controller 108 can work in conjunction for two-stage thermal throttling during operations of the electronic device 104. For example, during operations, the auxiliary controller 106 can first control a temperature by throttling the electronic device 104 and then, after the temperature reaches the second temperature threshold, the auxiliary controller 106 can hand off control to the main controller 108 to control the temperature of the electronic device 104. The auxiliary controller 106 may throttle a metric of the component 110 in a less aggressive or less drastic manner compared to the main controller 108. The purpose of the auxiliary controller 106 can be to dampen a temperature ramp rate of the electronic device 104 or to slow down a rate of change (e.g., decrease a ramp rate) of the temperature of the electronic device 104 before the temperature reaches a threshold at which control is handed off of to the main controller 108.

In one example, the auxiliary controller 106 is a proportional-only controller and the main controller 108 is a PI controller. A PI controller during a launch period accumulates a history of the tracked temperature before enforcing a meaningful throttling effect by its integrator. This accumulation can cause a delay in thermal throttling enforcement and can lead to high temperature overshoot in the electronic device 104, which can cause damage to components of the electronic device 104. The auxiliary controller 106 can collect thermal information or data during operations of the electronic device 104 as well as historical data regarding throttling actions of the auxiliary controller 106. This thermal information and historical data can be sent from the auxiliary controller 106 to the main controller 108 when control is handed off to the main controller 108. The handoff can be described as a handshake protocol to exchange information. The PI controller of the main controller 108 can use the thermal information and the historical data from the auxiliary controller 106 during the launch period, thus providing the PI controller with sufficient data for proper thermal throttling initialization and preventing the need for the main controller 108 to initialize thermal throttling from scratch. Furthermore, by using the thermal information and historical data from the auxiliary controller 106, the main controller 108 can launch more quickly as compared to an example without an auxiliary controller. The quicker launch time of the main controller 108 can prevent the delay in thermal throttling enforcement performed by the main controller 108, reduce temperature overshoot, and enable more-efficient temperature control by the main controller 108.

In one example, the thermal information and historical data regarding throttling actions of the auxiliary controller 106 that is sent to the main controller 108 can be in the form of initializing an integrator state of the PI controller of the main controller 108. In one example, the integrator state can be set to a value to enable an initial level of throttling induced by the PI controller to be equal to a last-enforced thermal throttling level achieved by the auxiliary controller 106. A proportional-only controller, which can be used for the auxiliary controller 106, can be lightweight, pro-active, and fast reacting. A proportional-only controller may not employ integrator accumulation and thus can react faster than a PI controller. Using a PI controller without an auxiliary controller, such as the auxiliary controller 106, can lead to a slower thermal control response or reaction and can cause high-temperature overshoot. Such high-temperature overshoot can cause a hardware component, a distributed file system, or a texture-mapping unit to reset or can cause a device shutdown event. In order to prevent such a reset or shutdown, the temperature threshold for the PI controller can be lowered. Such a solution, however, can slow down the performance of the electronic device 104 and negatively impact the user experience. Therefore, the techniques described herein employ the auxiliary controller 106, such as a proportional-only controller, at a first threshold for temperature and the main controller 108, such as a PI controller, at a second threshold for temperature. In an example, the second threshold is a higher temperature value than the first threshold.

The auxiliary controller 106 can monitor a temperature of the electronic device 104 during operations of the electronic device 104. For example, a sensor 120 of the electronic device 104 can be a temperature sensor that sends data to the auxiliary controller 106. The auxiliary controller 106 can then monitor the temperature and a rate of change of the temperature of the electronic device 104. The auxiliary controller 106 may take no throttling actions until the temperature of the electronic device 104 reaches a first threshold at a predetermined temperature and/or once the temperature reaches a first rate of change at a threshold rate of change. For example, the temperature of the electronic device 104 exceeding the first threshold for temperature may not be indicative that the electronic device 104 is going to pass a second, higher temperature threshold. Monitoring both the temperature and the rate of change of the temperature may indicate that the electronic device 104 is likely to exceed the second threshold for temperature. Accordingly, the auxiliary controller 106 may not thermally throttle the electronic device 104 until the temperature has exceeded the first threshold for temperature and the rate of change of the temperature has exceeded the threshold for rate of change.

Once the temperature of the electronic device 104 has exceeded the first threshold for temperature and exceeded the threshold for rate of change, the auxiliary controller 106 can thermally throttle device performance of the electronic device 104 to control the rising temperature of the electronic device 104. The auxiliary controller 106 can control a metric of the electronic device 104 or a component of the electronic device 104 to alter or decrease the rate of change, thus delaying the temperature from reaching the second threshold for temperature. In one example, after the temperature has exceeded the second threshold for temperature, the auxiliary controller 106 hands off control of thermal throttling to the main controller 108. In one example, the decrease in the rate of change of the temperature caused by the auxiliary controller 106 may lead to the temperature of the electronic device 104 not exceeding the second threshold for temperature and, therefore, the auxiliary controller 106 not handing off control to the main controller 108.

The decrease in the rate of change of temperature caused by the throttling employed by the auxiliary controller 106 can cause the rate of change of the temperature to change from a first rate of change to a second rate of change. This rate change can be described as changing the ramp rate of the temperature of the electronic device 104. The main controller 108 can also receive temperature data from the sensor 120. It should be appreciated that the electronic device 104 can have more than one sensor 120 to monitor temperature and also more than one type of sensor 120 to monitor temperature. The auxiliary controller 106 and the main controller 108 may use the same sensor(s) or a different sensor(s) for monitoring the temperature of the electronic device 104. One or more sensors 120 can be integrated with, or coupled to, the CPU 112, the GPU 114, the display 116, and/or the speaker 118. It should be appreciated that many uses of electronic devices may not result in high ramp rates of temperature and may not result in exceeding the second threshold for temperature. Therefore, the techniques described herein provide an elegant solution for slowing down a high ramp rate in corner cases for when an electronic device does have a high ramp rate and is likely to exceed the second threshold for temperature.

The sensor 120 can provide the rate of change of the temperature to the auxiliary controller 106 or the main controller 108. Alternatively, the auxiliary controller 106 can use data received from the sensor 120 to calculate the rate of change of the temperature. In some examples, an algorithm used to calculate the temperature of the electronic device 104 or to calculate the rate of change of the temperature can also generate thermal heat in the electronic device 104. Therefore, an algorithm used for such calculations may be selected based on the thermal load caused by the algorithm. An interval or period of time in which the auxiliary controller 106 receives data from the sensor 120 regarding temperature can be any interval, such as every 100 milliseconds, every second, every minute, etc. A smaller (shorter) interval may cause the auxiliary controller 106 to inaccurately monitor the rate of change of the temperature of the electronic device 104. The interval may also be tunable.

By employing both an auxiliary controller and a main controller, using the techniques described herein, transient thermal control of a device can be improved and severe performance degradation of the device can be avoided. In other words, the auxiliary controller 106 can reduce the rate of increase (e.g., ramp rate) in temperature of the electronic device 104 before the temperature exceeds the second temperature threshold and triggers the main controller 108 to implement more drastic measures to control the temperature. The auxiliary controller 106 and the main controller 108 can be adjustable, which enables an adjustable tradeoff between cooling caused by thermal throttling of the electronic device 104 and device performance, which can result in a degradation in user experience, caused by the thermal throttling.

A metric of the electronic device 104 that can be throttled by the auxiliary controller 106 or the main controller 108 can be, but is not limited to, a voltage, a frequency, an output volume of a speaker, or a brightness of a display. For example, the voltage can be a voltage of the CPU 112, the GPU 114, or any other component of the electronic device 104. In one example, the auxiliary controller 106 and the main controller 108 thermally control or throttle the same metric as one another. In another example, the auxiliary controller 106 and the main controller 108 thermally control or throttle different metrics from one another. In some examples, the main controller 108 thermally controls or throttles more metrics than the auxiliary controller 106.

In one example, the first temperature threshold, the second temperature threshold, and the threshold rate of change associated with the electronic device 104, the auxiliary controller 106, and the main controller 108 each have a value that is preset or predetermined. The respective values of the first temperature threshold, the second temperature threshold, and the threshold rate of change can be tunable and changed to a different value. This tunable feature can enable different levels of tradeoff between the thermal cooling and the device performance.

In one example, the electronic device 104 is a smart phone and the auxiliary controller 106 and the main controller 108 control the CPU 112 of the smart phone. The metric being controlled for thermal throttling can be the voltage or power used by the CPU 112. Alternatively, the display 116 of the smart phone can be controlled where the metric being thermally throttled is a brightness of the display 116, such as a percentage, a ratio, or another value corresponding to the brightness. Alternatively, the speaker 118 of the smart phone can be controlled where the metric being thermally throttled is a volume of the speaker 118, such as a percentage, a ratio, or another value corresponding to the volume.

In another example, the electronic device 104 includes a system-on-a-chip (SoC). In this example, the auxiliary controller 106 and the main controller 108 control the GPU 114. The metric being controlled for thermal throttling can be the voltage, power, and/or frequency of the GPU 114.

In some examples, the electronic device 104 includes an integrated circuit as part of the CPU 112 and the techniques described herein control a temperature of the integrated circuit. A dynamic voltage and frequency scaling (DVFS) method can be utilized to control the CPU 112 temperature. A PI controller can be employed for the main controller 108 to select different values in a DVFS table index and enforce a corresponding voltage and frequency to address thermal-control objectives. If there is no auxiliary controller, then when the temperature reaches a PI loop target (e.g., the second temperature threshold), throttling will start from a maximum voltage and frequency, which causes a high temperature ramp rate and, depending on a software implementation delay or bottlenecks, can result in a high temperature overshoot with potential performance implications. The auxiliary controller 106 can help by ensuring that when the PI loop triggers, the main controller 108 starts to throttle from a DVFS table index, which corresponds to a lower-than-maximum voltage and frequency. This table index is a tunable parameter and can depend on the gain of the auxiliary controller 106 and a distance between the PI loop target and a proportional loop target (e.g., the first temperature threshold).

It should be appreciated that although temperature thresholds are used in the disclosed examples, other thresholds can be used. For example, the disclosed techniques can be implemented using power thresholds. Using a correlation between power generation and heat generation, device power generation can be monitored and a two-stage throttling can be implemented to reduce the temperature ramp rate.

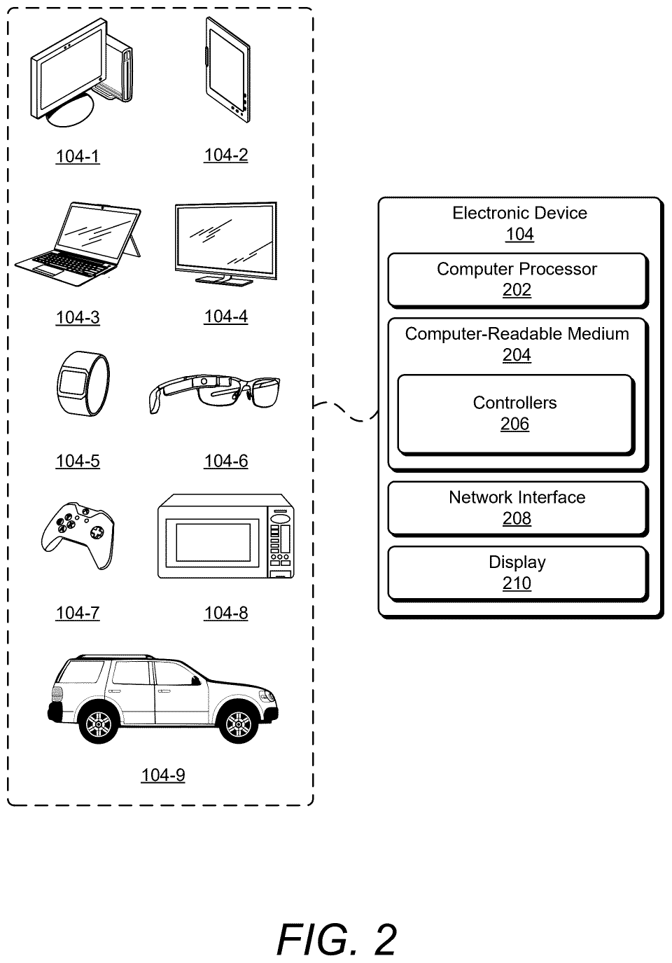

FIG. 2 illustrates an example of the electronic device 104 from FIG. 1. The electronic device 104 is illustrated with various non-limiting example devices in addition to smart phones, including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the electronic device 104 can be wearable, non-wearable but mobile, or relatively immobile (e.g., desktops and appliances).

The electronic device 104 includes one or more computer processors 202 and at least one computer-readable medium 204, which includes memory media and storage media. Applications and/or an operating system (not shown) embodied as computer-readable instructions on the computer-readable medium 204 can be executed by the computer processor 202 to provide some of the functionalities described herein. The computer-readable medium 204 also includes controllers 206, such as the auxiliary controller 106 and the main controller 108 of FIG. 1, which use information provided by the sensor 120 to perform an action. Example actions can include thermally controlling or throttling a metric of a component.

The electronic device 104 can also include a network interface 208 for communicating data over wired, wireless, or optical networks. For example, the network interface 208 may communicate data over a local-area network (LAN), a wireless local-area network (WLAN), a personal-area network (PAN), a wide-area network (WAN), an intranet, the Internet, a peer-to-peer network, a point-to-point network, a mesh network, Bluetooth®, and the like. The electronic device 104 may also include a display 210.

### Two-Stage Thermal Throttling

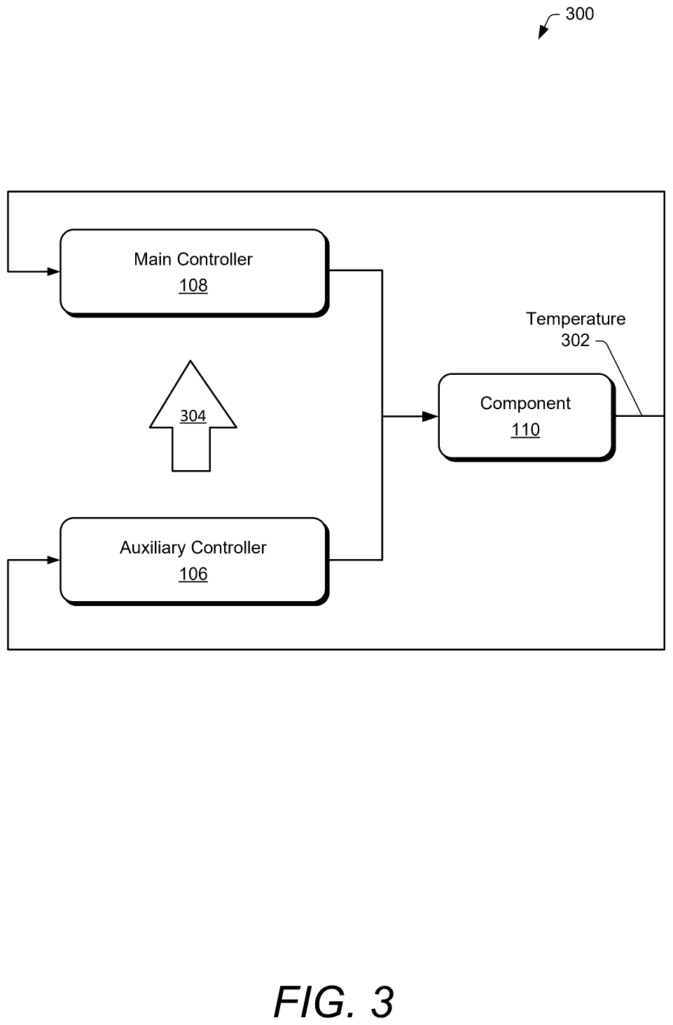

FIG. 3 illustrates an example block diagram of a flow 300 for two-stage thermal throttling. The flow 300 includes an auxiliary controller 106 and a main controller 108. The auxiliary controller 106 monitors temperature 302 and a rate of change of the temperature 302 of a device or a component (e.g., the component 110) of the device by obtaining data from a sensor. The auxiliary controller 106 determines that the temperature 302 has exceeded a first temperature threshold as well as a threshold rate of change for temperature. Based on this determination, the auxiliary controller 106 controls (e.g., throttles) a metric of the component 110 of the device to decrease the rate of change of the temperature 302 of the device. In some cases, the temperature 302 continues to rise, albeit at a slower rate. After the temperature 302 has exceeded a second temperature threshold, the auxiliary controller 106 hands off control of the metric to the main controller 108. As part of the handoff, the auxiliary controller 106 provides information handoff 304 to the main controller 108. The information handoff 304 can include thermal information of the device and historical data regarding actions of the auxiliary controller 106 to reduce the rate of change of the temperature 302. The main controller 108 then throttles the temperature 302 of the device by controlling one or more metrics of the component 110.

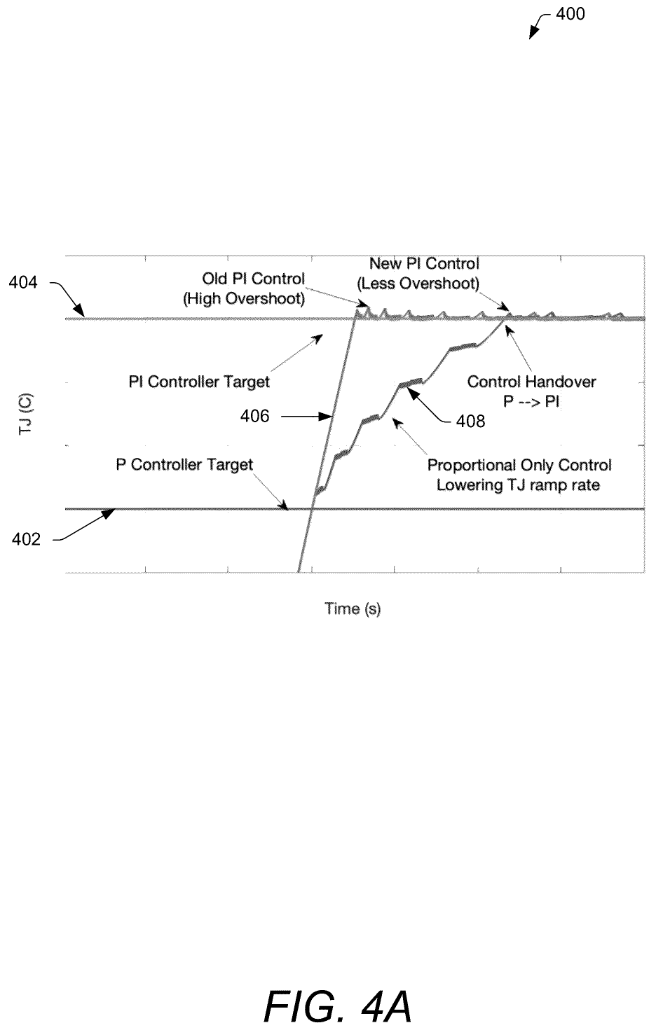

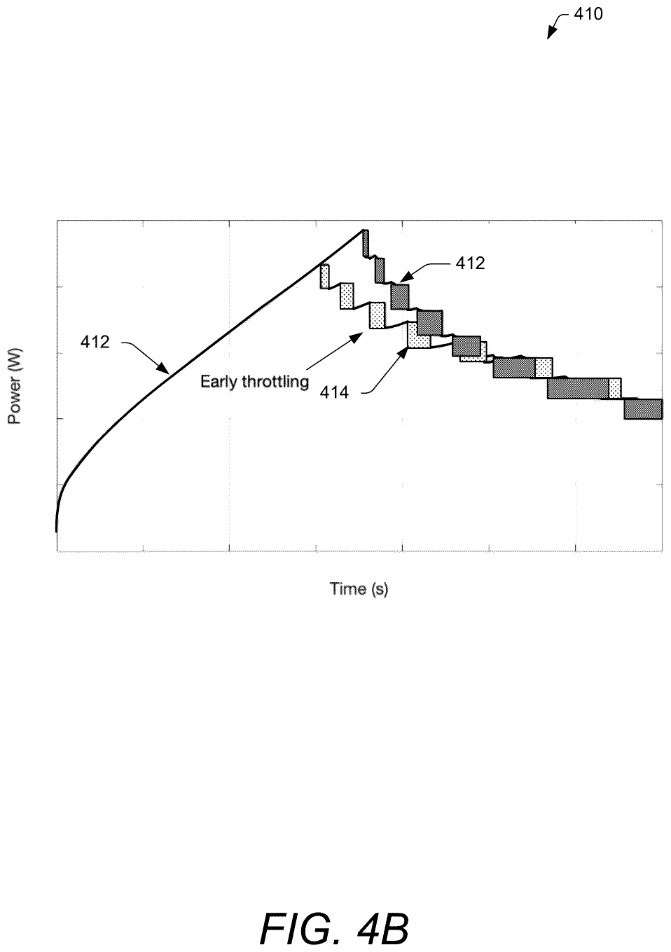

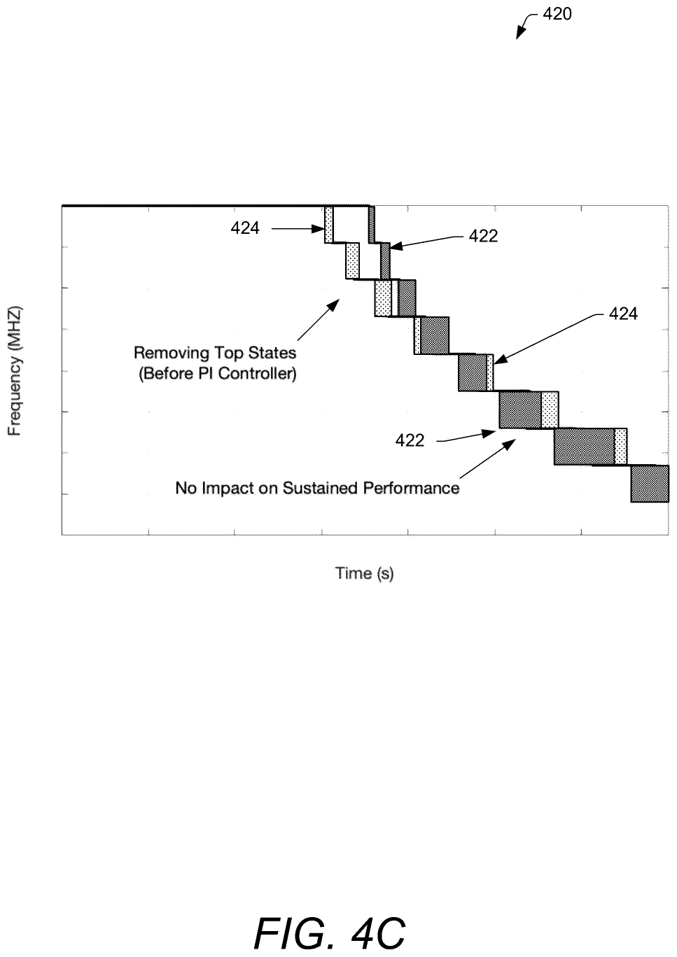

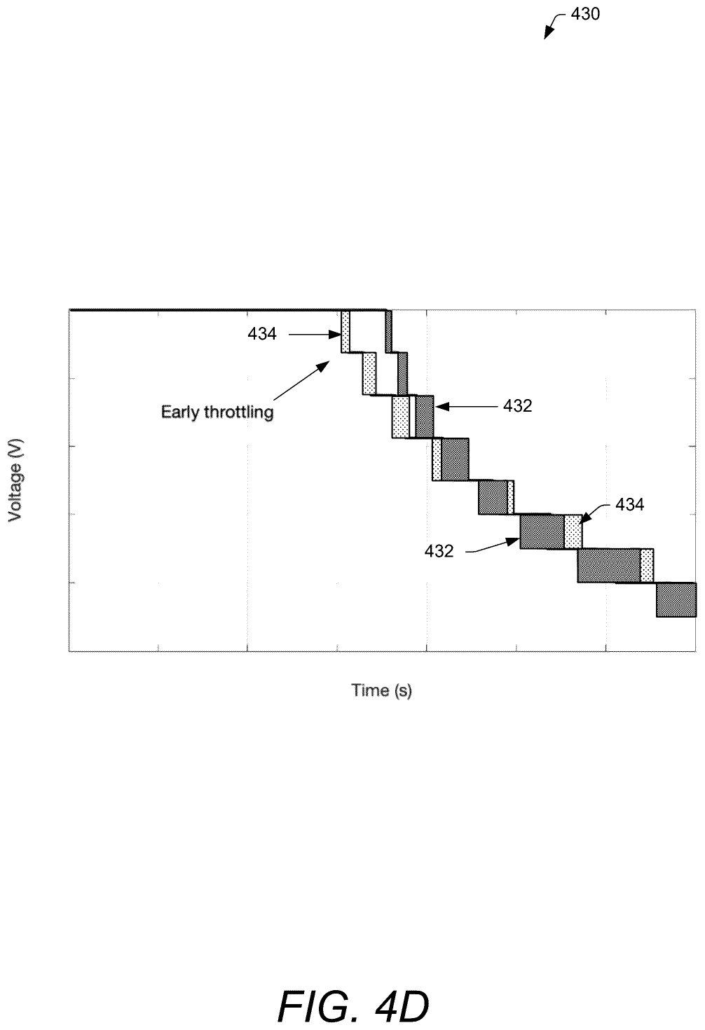

FIGS. 4A-D depict graphs of the temperature being throttled by the auxiliary controller 106 and the main controller 108. The graphs shown in FIGS. 4A-D depict comparisons between a conventional device using only a PI controller (without the auxiliary controller 106) and a device that uses the disclosed techniques with both the auxiliary controller 106 and the main controller 108.

FIG. 4A depicts a graph 400 of temperature vs. time. Line 402 represents a first temperature threshold and line 404 represents a second temperature threshold. Line 406 represents a conventional solution where a temperature of a device is controlled with only a main controller, such as a PI controller. Line 408 represents an implementation as described herein that employs both an auxiliary controller, such as a proportional-only (P) controller, and a main controller for two-stage thermal throttling. Line 408 depicts results of the auxiliary controller performing early thermal throttling to control a ramp rate of the temperature. Notice how the temperature of line 408 rises more slowly than the temperature of line 406 due to the early throttling performed by the auxiliary controller. As illustrated, the early throttling by the auxiliary controller increases the time lapsed before the temperature reaches the second temperature threshold (line 404). Further, because the ramp rate is reduced, based on the throttling of the auxiliary controller, temperature overshoot of line 408 is also reduced in comparison to the conventional solution (line 406).

FIG. 4B depicts a graph 410 of power vs. time. Line 412 represents a conventional solution where a power of a device is controlled with only a main controller. Line 414 represents an implementation as described herein that employs both an auxiliary controller and a main controller for two-stage thermal throttling. Notice how, with early throttling, line 414 drops off earlier than line 412, thus depicting how power is controlled via the early throttling. This early drop in power usage is due to the early throttling performed by the auxiliary controller. As illustrated, the early throttling by the auxiliary controller sacrifices a small amount of power, and consequently device performance, to reduce the likelihood of high temperature overshoot and potential damage to the device.

FIG. 4C depicts a graph 420 of frequency vs. time. Line 422 represents a conventional solution where a temperature of a device is controlled with only a main controller. Line 424 represents an implementation as described herein that employs both an auxiliary controller and a main controller for two-stage thermal throttling. Notice how, with early throttling, line 424 drops off earlier than line 422, thus depicting how frequency is controlled via the early throttling. This early drop-off is due to the early throttling performed by the auxiliary controller. As illustrated, the early throttling by the auxiliary controller leaves no impact on sustained performance as it relates to temperature.

FIG. 4D depicts a graph 430 of voltage vs. time. Line 432 represents a conventional solution where a temperature of a device is controlled with only a main controller. Line 434 represents an implementation as described herein that employs both an auxiliary controller and a main controller for two-stage thermal throttling. Notice how, with early throttling, line 434 drops off earlier than line 432, thus depicting how voltage is controlled via the early throttling. This early drop-off is due to the early throttling performed by the auxiliary controller. As illustrated, the early throttling by the auxiliary controller leaves no impact on sustained performance.

### Example Methods

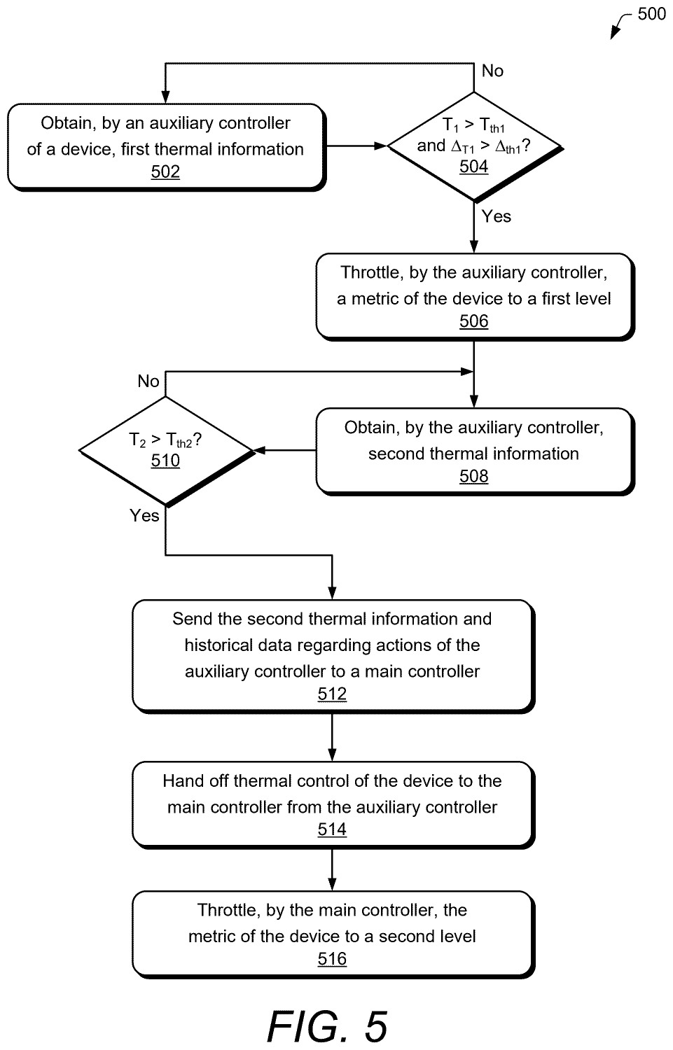

FIG. 5 depicts an example method 500 for implementing aspects of two-stage thermal throttling. The method 500 is shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIGS. 2 and 3, reference to which is made for example only. The techniques are not limited to performance by one entity or multiple entities operating on one device.

At 502 in FIG. 5, first thermal information regarding a first temperature T₁ of a device (e.g., the electronic device 104) and a first rate of increase Δ_{T1} of the first temperature T₁ is obtained by an auxiliary controller (e.g., the auxiliary controller 106) of the device. The auxiliary controller can be a proportional controller. In one example, the auxiliary controller does not accumulate temperature error, which is when the temperature measured by a sensor differs from the actual temperature. In another example, the auxiliary controller is configured to discard error history.

At 504, a determination is made as to whether the first temperature T₁ of the device has exceeded a first temperature threshold Tₜₕ₁ and whether the first rate of increase Δ_{T1} the first temperature T₁ has exceeded a threshold rate of increase Δₜₕ₁. In one example, the first rate of increase Δ_{T1} of the first temperature T₁ is caused by operation of a component (e.g., the component 110) of the device, such as the CPU 112, the GPU 114, the display 116, or the speaker 118. If the first temperature T₁ has not exceeded the first temperature threshold Tₜₕ₁ and/or the first rate of increase Δ_{T1} of the first temperature T₁ has not exceeded the threshold rate of increase Δₜₕ₁ (“NO” at 504), the method loops back to 502 to continue monitoring the thermal information of the device. If the first temperature T₁ has exceeded the first temperature threshold Tₜₕ₁ and the first rate of increase Δ_{T1} of the temperature T₁ has exceeded the threshold rate of increase Δₜₕ₁ (“YES” at 504), the method proceeds to 506.

At 506, a metric of the device is throttled by the auxiliary controller to a first level to adjust the first rate of increase Δ_{T1} of the temperature T₁ to a second rate of increase Δ_{T2} in response to the first temperature threshold Tₜₕ₁ and the threshold rate of increase Δₜₕ₁ being exceeded. In one example, the metric is associated with the component 110 of the device, such as a voltage, a frequency, a percentage of volume of a speaker, or a percentage of brightness of a display.

At 508, second thermal information regarding a second temperature T₂ of the device is obtained by the auxiliary controller of the device. For example, the auxiliary controller 106 continues monitoring the device temperature by obtaining additional thermal information. In aspects, the second thermal information is obtained via a same sensor (e.g., the sensor 120) used to obtain the first thermal information, such that the second thermal information corresponds to the same location or component of the device (e.g., the CPU 112, the GPU 114, the display 116, the speaker 118).

At 510, a determination is made as to whether the second temperature T₂ of the device has exceeded a second temperature threshold Tₜₕ₂. It should be appreciated that the first temperature threshold Tₜₕ₁, the second temperature threshold Tₜₕ₂, and the threshold rate of increase Δₜₕ₁ each have a value and are tunable to be changed to a different value. In one example, the first temperature threshold Tₜₕ₁ is a lower value than the second temperature threshold Tₜₕ₂. If the second temperature T₂ has not exceeded the second temperature threshold Tₜₕ₂ (“NO” at 510), the method 500 loops back to 508 to continue monitoring the device temperature. If the second temperature T₂ has exceeded the second temperature threshold Tₜₕ₂ (“YES” at 510), the method 500 proceeds to 512.

At 512, the second thermal information and historical data regarding actions of the auxiliary controller are sent to a main controller (e.g., the main controller 108) of the device. In one example, the historical data regarding actions of the auxiliary controller 106 is a table index that corresponds to lower-than-maximum adjustments made to the metric by the auxiliary controller 106. In aspects, the main controller 108 is a PI controller. In one example, a memory element of the PI controller is initialized to a value equal to a last level set by the auxiliary controller 106.

At 514, thermal control of the device is handed off to the main controller from the auxiliary controller. For example, the auxiliary controller 106 performs a handoff procedure for thermal control of the electronic device 104 to the main controller 108.

At 516, the metric of the device is throttled by the main controller to a second (e.g., different) level to adjust the temperature of the device. For example, the main controller 108 can perform thermal throttling in a more aggressive manner compared to that of the auxiliary controller 106, to prevent the temperature from reaching critical limits that can result in damage to the electronic device 104. The thermal throttling by the main controller 108 can include throttling the metric and/or one or more additional metrics.

### Example Computing System

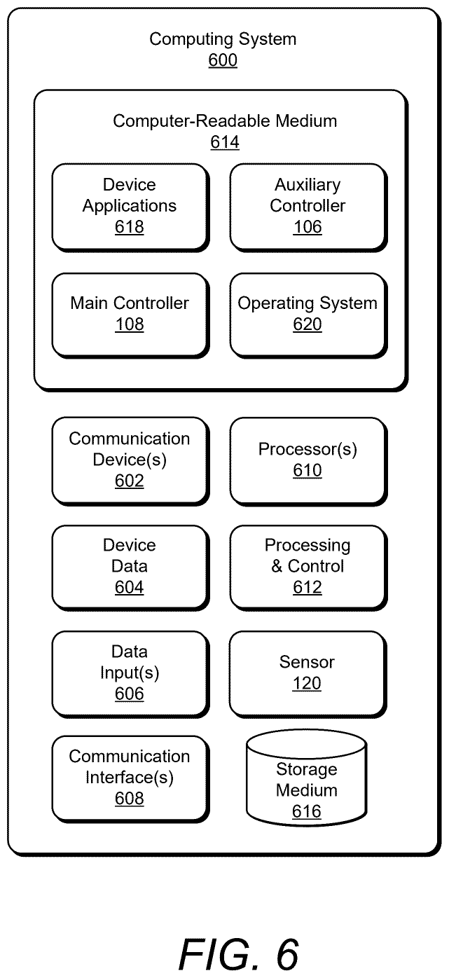

FIG. 6 illustrates various components of an example computing system 600 that can be implemented as any type of client, server, and/or computing device and methods as described with reference to the previous FIGS. 1-5 to implement aspects of two-stage thermal throttling.

The computing system 600 includes communication devices 602 that enable wired and/or wireless communication of device data 604 (e.g., received data, data that is being received, data scheduled for broadcast, or data packets of the data). The device data 604 or other device content can include configuration settings of the device, media content stored on the device, and/or information associated with a user of the device. Media content stored on the computing system 600 can include any type of audio, video, and/or image data. The computing system 600 includes one or more data inputs 606 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 600 also includes communication interfaces 608 (e.g., network interface 208), which can be implemented as any one or more of a serial and/or parallel interface, a wireless interface, any type of network interface, a modem, and any other type of communication interface. The communication interfaces 608 provide a connection and/or communication links between the computing system 600 and a communication network by which other electronic, computing, and communication devices communicate data with the computing system 600.

The computing system 600 includes one or more processors 610 (e.g., any of microprocessors, controllers, and the like), which process various computer-executable instructions to control the operation of the computing system 600. Alternatively or in addition, the computing system 600 can be implemented with any one or combination of hardware, firmware, or fixed logic circuitry that is implemented in connection with processing and control 612 circuits. An example of the processors 610 includes the computer processor 202. Although not shown, the computing system 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 600 also includes a computer-readable medium 614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, erasable programmable read-only memory (EPROM), electrically erasable programmable read-only memory (EEPROM), etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 600 can also include a mass storage medium device (storage medium) 616.

The computer-readable medium 614 (e.g., the computer-readable medium 204) provides data storage mechanisms to store the device data 604, as well as various device applications 618 and any other types of information and/or data related to operational aspects of the computing system 600. For example, an operating system 620 can be maintained as a computer application with the computer-readable medium 614 and executed on the processors 610. The device applications 618 may include a device manager, such as any form of a control application, a software application, a signal-processing and control module, code that is native to a particular device, a hardware abstraction layer for a particular device, and so on.

The device applications 618 also include any system components, engines, managers, auxiliary controllers, or main controllers, to implement two-stage thermal throttling. In this example, device applications 618 can implement the auxiliary controller 106 or the main controller 108 of FIG. 1, which can be stored on the computer-readable medium 614. The computing system 600 also includes one or more sensors 120, such as a temperature sensor, configured to measure the temperature of the computing system 600, including a temperature associated with the processors(s) 610 (e.g., the CPU 112, the GPU 114) or any other component or location in the computing system 600.

### CONCLUSION

Although techniques using, and apparatuses including, two-stage thermal throttling have been described in language specific to features and/or methods, it is to be understood that the subject of the appended claims is not necessarily limited to the specific features or methods described. Rather, the specific features and methods are disclosed as example implementations of two-stage thermal throttling.

What is claimed is:

1. A method comprising:
obtaining, by an auxiliary controller of a device, first thermal information regarding a first temperature of the device and a first rate of increase of the first temperature;
determining that the first temperature has exceeded a first temperature threshold and that the first rate of increase of the first temperature has exceeded a threshold rate of increase;
throttling, by the auxiliary controller, a metric of the device to a first level to adjust the first rate of increase of the first temperature to a second rate of increase in response to the first temperature threshold and the threshold rate of increase being exceeded;
obtaining, by the auxiliary controller, second thermal information regarding a second temperature of the device;
determining that the second temperature of the device has exceeded a second temperature threshold;
sending the second thermal information and historical data regarding actions of the auxiliary controller to a main controller of the device in response to the second temperature threshold being exceeded;
handing off thermal control of the device to the main controller from the auxiliary controller in response to the second temperature of the device exceeding the second temperature threshold; and
throttling, by the main controller, the metric of the device to a second level to adjust the second temperature of the device.

2. The method of claim 1, wherein the main controller is a Proportional and Integral (PI) controller and a memory element of the PI controller is initialized to a value equal to a last level set by the auxiliary controller.

3. The method of claim 1, wherein the auxiliary controller is a proportional-only controller.

4. The method of claim 1, wherein the first rate of increase of the first temperature is caused by operation of a component of the device and the component of the device is a central processing unit (CPU), a graphical processing unit (GPU), a display, or a speaker.

5. The method of claim 1, wherein the metric is associated with a component of the device and is a voltage, a frequency, a percentage of volume of a speaker, or a percentage of brightness of a display.

6. The method of claim 1, wherein the first temperature threshold, the second temperature threshold, and the threshold rate of increase each have a value and are tunable to be changed to a different value.

7. The method of claim 1, wherein the first temperature threshold is a lower value than the second temperature threshold.

8. The method of claim 1, wherein the auxiliary controller does not accumulate temperature error.

9. The method of claim 1, wherein the historical data regarding actions of the auxiliary controller is a table index that corresponds to lower-than-maximum adjustments made to the metric.

10. A device, comprising:
a component;
an auxiliary controller configured to:
obtain first thermal information regarding a first temperature of the component and a first rate of increase of the first temperature;
determine that the first temperature of the component has exceeded a first temperature threshold and that the first rate of increase of the first temperature has exceeded a threshold rate of increase;
throttle a metric of the component to a first level to adjust the first rate of increase of the first temperature to a second rate of increase in response to the first temperature threshold and the threshold rate of increase being exceeded;
obtain second thermal information regarding a second temperature of the component; and
determine that the second temperature of the component has exceeded a second temperature threshold; and
a main controller configured to:
receive the second thermal information and historical data regarding actions of the auxiliary controller in response to the second temperature of the component exceeding the second temperature threshold;
receive a handoff of thermal control of the component from the auxiliary controller in response to the second temperature of the component exceeding the second temperature threshold; and
throttle the metric of the component to a second level to adjust the second temperature of the component.

11. The device of claim 10, wherein the main controller is a Proportional and Integral (PI) controller and a memory element of the PI controller is initialized to a value equal to a last level set by the auxiliary controller.

12. The device of claim 10, wherein the auxiliary controller is a proportional-only controller.

13. The device of claim 10, wherein the component is a central processing unit (CPU), a graphical processing unit (GPU), a display, or a speaker.

14. The device of claim 10, wherein the metric is associated with a component of the device and is a voltage, a frequency, a percentage of volume of a speaker, or a percentage of brightness of a display.

15. The device of claim 10, wherein the device is a small form factor electronic device.

16. A computer-readable storage medium comprising instructions that, responsive to execution by a processor, cause a device to perform a method, comprising:
obtaining, by an auxiliary controller of a device, first thermal information regarding a first temperature of the device and a first rate of increase of the first temperature;
determining that the first temperature has exceeded a first temperature threshold and that the first rate of increase of the first temperature has exceeded a threshold rate of increase;
throttling, by the auxiliary controller, a metric of the device to a first level to adjust the first rate of increase of the first temperature to a second rate of increase in response to the first temperature threshold and the threshold rate of increase being exceeded;
obtaining, by an auxiliary controller of a device, second thermal information regarding a second temperature of the device;
determining that the second temperature of the device has exceeded a second temperature threshold;
sending the second thermal information and historical data regarding actions of the auxiliary controller to a main controller of the device in response to the second temperature threshold being exceeded;
handing off thermal control of the device to the main controller from the auxiliary controller in response to the second temperature of the device exceeding the second temperature threshold; and
throttling, by the main controller, the metric of the device to a second level to adjust the second temperature of the device.

17. The computer-readable storage medium of claim 16, wherein the main controller is a Proportional and Integral (PI) controller and a memory element of the PI controller is initialized to a value equal to a last level set by the auxiliary controller, and wherein the auxiliary controller is a proportional-only controller.

18. The computer-readable storage medium of claim 16, wherein the first rate of increase of the first temperature is caused by operation of a component of the device and the component of the device is a central processing unit (CPU), a graphical processing unit (GPU), a display, or a speaker.

19. The computer-readable storage medium of claim 16, wherein the metric is associated with a component of the device and is a voltage, a frequency, a percentage of volume of a speaker, or a percentage of brightness of a display.

20. The computer-readable storage medium of claim 16, wherein the first temperature threshold, the second temperature threshold, and the threshold rate of increase each have a value and are tunable to be changed to a different value.
